(19) United States
(12) Patent Application Publication
(10) Pub. No.: US 2011/0233136 A1
(43) Pub. Date: Sep. 29, 2011

(54) Water Treatment Process

(75) Inventors: Michael L. Enos, Colorado Springs, CO (US); Randal R. Gingrich, Monument, CO (US); William R. Henchel, Palmer Lake, CO (US)

(73) Assignee: AUXSOL, INC., Colorado Springs, CO (US)

(21) Appl. No.: 13/061,715

(22) PCT Filed: Sep. 2, 2009
(86) PCT No.: PCT/US09/55798

§ 371 Date: Jun. 15, 2011

Related U.S. Application Data
(60) Provisional application No. 61/142,611, filed on Jan. 5, 2009.

(51) Int. Cl. C02F 9/00

(52) U.S. Cl. 210/631

(57) ABSTRACT

The present invention provides a process for treating water that comprises chloride ions, other ions (e.g., ferrous ions, sulfide ions, or sulfite ions) and microorganisms.

### CROSS-REFERENCE TO RELATED APPLICATIONS

This application claims the priority benefit of U.S. Provisional Application No. 61/142,611, filed Jan. 5, 2009, which is incorporated herein by reference in its entirety.

### FIELD OF THE INVENTION

The present invention relates to a process for treating water that comprises various ions and microorganisms.

### BACKGROUND OF THE INVENTION

In many oil and gas production processes, large volumes of highly contaminated, water (called “produced water”) (PW) is produced along with the production of hydrocarbons. For example, operators in the South Mid-continent Region of the Petroleum Technology Transfer Council (PTTC) have identified PW as a major constraint in the production of hydrocarbons. The costs of lifting, separating, handling, treating, and disposing of this water are substantial.

A type or subset of produced water is referred to as flowback water. This water typically results from hydraulic fracing of gas wells and flows back to the surface after fracturing sometimes flowing back for several days. Flowback water can contain numerous chemicals such as biocides, friction reducers, emulsifiers, surfactants and other chemicals in addition to minerals and hydrocarbons contained in the reservoir water.

Much has been researched on the problems involving the use and disposal of water in the oil and gas industry. This problem is more pronounced in semi-arid regions of the Western U.S. However, even in regions where water is not as scarce, a large quantity of source water is used by the oil and gas industry. This creates a significant problem of treating and/or disposing of large volumes of contaminated PW. Because of these high water demand and disposal issues, the oil and gas industry competes with local industry, communities and environmentalists on water use and disposal issues.

Often, reusing untreated PW for well-fracturing (fracing) operations is not viable due to the large potential these waters have in fouling or scaling underground geologic formations, which then impedes the production of hydrocarbons. Fouling generally refers to the formation of slime and/or solids in the underground fracture matrix that reduces or prevents the release and flow of hydrocarbons. Typically, fouling in production wells makes them less or non-productive.

Scaling is different from fouling. Scaling generally refers to water's capacity or ability to produce scale, which is primarily caused by hardness ions, such as calcium and magnesium. In some instances, Langelier Saturation Index (LSI) is used as an indicator of calcium carbonate scaling potential. As discussed above, fouling also can include bacteria, e.g., slime forming bacteria such as IRB and SRB. Since IRB and SRB also contribute to carbonate scaling potential, it some water samples there is an inter-relationship between scaling and fouling created by the presence of bacteria.

Without being bound by any theory, the fouling and/or scaling potentials (i.e., likelihood or probability of fouling and/or scaling, respectively) of PW is believed to be caused by high concentrations of colloids, e.g., total dissolved solids (TDS) and/or total suspended solids (TSS). In addition, some ions and compounds such as, but not limited to, iron, silica and sulfur compounds as well as bacteria such as iron and/or sulfur reducing bacteria (IRB and/or SRB, respectively) also contribute to fouling and/or scaling potentials. Thus, reusing or discharging PW without treatment jeopardizes hydrocarbon production or creates serious environmental problems.

While there has been much research to address problems associated with disposing of PW in the oil and gas industry, conventional processes generally require large amounts of harsh chemicals (e.g., caustics), making such treatments ineffective and/or not commercially economical.

Therefore, there is a need for more effective and/or economical processes to treat produced and flowback water or water supplies and sources used as makeup water for hydraulic fracing of wells.

### SUMMARY OF THE INVENTION

Some aspects of the invention provide processes for treating water which comprises chloride ion, an oxidizable ion, suspended solids, and an ion reducing bacteria. Generally, the oxidizable ion comprises ferrous ion, sulfide ion, sulfite ion, or a mixture thereof. Typical ion reducing bacteria comprises iron reducing bacteria (IRB), sulfur reducing bacteria (SRB), or a combination thereof. Processes of the invention result in water that is substantially free of ion reducing bacteria and a significant reduction in the amount of suspended solids. Within these aspects, processes of the invention typically comprise:
oxidizing the oxidizable ion to an oxidized ion;
reducing the amount of ion reducing bacteria to produce a substantially ion reducing bacteria free water;
subjecting the substantially ion reducing bacteria free water to conditions sufficient to precipitate suspended solids; and
separating at least a substantial portion of the precipitated suspended solids from the substantially ion reducing bacteria free water to produce a treated water.

It should be appreciated that the step of oxidizing oxidizable ion to an oxidized ion refers to converting ferrous ions to ferric ions, and sulfide and/or sulfite ions to sulfate ions.

In some instances, some precipitation can occur prior to subjecting the suspended solids to precipitating conditions. In such instances, the precipitates are often removed prior to subjecting the suspended solids to further precipitating conditions.

In other embodiments, the step of oxidizing the oxidizable ion to the oxidized ion comprises an electrochemical process of converting chloride ion to chlorine. Any conventional methods for electrochemical conversion of chloride ion to chlorine can be used. Alternatively, an oxidizing agent can be used to oxidize the oxidizable ions to the oxidized ions. Suitable oxidizing agents are well known to one skilled in the art and include, but are not limited to, ozone, bleach, chlorine dioxide, as well as other oxidizing agents.

Still in other embodiments, the step of reducing the amount of ion reducing bacteria comprises electrochemical process. Within these embodiments, in some cases the electrochemical process of reducing the amount of ion reducing bacteria comprises converting chloride ion to chlorine. The amount of ion reducing bacteria can also be reduced without the use of electrochemical process. For example, the amount of ion reducing bacteria can be reduced by adding anti-microbial compounds that are well known to one skilled in the art including, but not limited to, chlorine, bromine, ozone, bleach, chlorine dioxide, etc.

In some embodiments, precipitation can occur prior to subjecting the water to precipitating conditions. In such instances, precipitates are removed prior to subjecting the water to precipitating conditions. This is particularly true when precipitating conditions for suspended solids include an electrocoagulation process as the presence of solids may reduce the efficiency of an electrocoagulation device.

In some embodiments, the step of precipitating the suspended solids comprises producing flocculates, ferric hydroxide (Fe(OH)₃) or a combination thereof. Within these embodiments, in some instances, the step of precipitating suspended solids comprises subjecting the substantially ion reducing bacteria free water to an electrocoagulation process. Any electrocoagulation device known to one skilled in the art can be used. In some cases, the electrocoagulation process uses an electrocoagulation device such as those disclosed in the commonly owned U.S. Provisional Patent Application No. 61/093,706, filed Sep. 2, 2008, and a PCT Patent Application Number PCT/US09/55797, filed Sep. 2, 2009, which are incorporated herein by reference in their entirety. In one particular case, the electrocoagulation device comprises:
(a) an electrically conducting tube comprising:
   an inner diameter,
   an outer diameter,
   a first orifice, and
   a second orifice distal to said first orifice for allowing a fluid to flow out of said electrocoagulation device;
(b) an electrically conducting tube insert located and positioned within said tube such that there is an annular space between said tube and said tube insert, wherein said tube insert comprises:
   a fluid inlet located proximal to said first orifice of said tube for allowing a fluid to flow into said electrocoagulation device, and
   a plurality of fluid outlet orifices for allowing a fluid to flow out of said tube insert and into the annular space of said electrocoagulation device; and
(c) a non-electrically conducting connector located proximal to said first orifice and connecting said tube and said tube insert such that said tube and said tube insert are electrically isolated from one another,
   wherein one of said tube and said tube insert forms an anode and the other forms a cathode of the electrocoagulation device.

In some instances, the electrocoagulation device further comprises an electrically non-conducting material within the annular space of the electrocoagulation device such that the electrically non-conducting material prevents a direct contact between electrically conducting tube and the tube insert.

Yet in other embodiments, the electrocoagulation process uses a plurality of electrocoagulation devices. The plurality of electrocoagulation devices can be arranged in series or parallel. In some instances, the electrocoagulation devices are arranged in series.

Still in other embodiments, the electrocoagulation process accomplishes a plurality of steps including (1) oxidizing the oxidizable ion to the oxidized ion; (2) reducing the amount of ion reducing bacteria; and (3) precipitating suspended solids.

In other embodiments, the step of separating at least a substantial portion of the precipitated suspended solids comprises placing the substantially ion reducing bacteria free water in a solid separation device. Within these embodiments, in some instances, the solid separation device comprises an incline plate settler, settling tank, centrifuge, other enhanced gravity separation device, or a combination thereof.

In some embodiments, hardness ions are removed from the water as a carbonate, for example, by adding a carbonate source such as trona, carbon dioxide, and other sources of carbonate ions. Hardness ions can be removed from water at any point during the water treatment process. Often, it is removed after subjecting the water to an electrocoagulation process.

Yet in other embodiments, processes of the invention further comprise the step of filtering the treated water. Such filtration step reduces flocculates and/or the odor of the treated water.

In some instances the treated water comprises chlorine or other oxidizing agent. The presence of chlorine or other oxidizing agent serves to ensure elimination of ion reducing bacteria, reduction in the amount of the oxidizable ions, or both.

Often the separated precipitated suspended solids are highly compressible. Thus, a high compaction can be achieved, thereby reducing the volume of solids for disposal.

Unlike other conventional processes, the precipitates of the invention comprise a relatively high amount of solids. In some instances, the separated precipitated suspended solids comprise at least about 3.5%, typically at least about 5%, and often at least about 7%, solids by weight.

### BRIEF DESCRIPTION OF THE DRAWINGS

FIG. 1 is a schematic illustration of one particular embodiment of the process for treating water in accordance with the present invention; and

FIGS. 2-3 are schematic drawings of various views of one particular embodiment of an electrocoagulation device that can be used with processes of the present invention.

### DETAILED DESCRIPTION OF THE INVENTION

A wide variety of chemical and mechanical processes have been developed in an effort to control pollution from effluent streams such as in oil and gas production. Impurities in these streams include colloids (e.g., suspended solids and/or dissolved particles), various ions (e.g., ferrous ions, sulfides, sulfites, etc.), and/or microorganisms (e.g., iron reducing bacteria, sulfur reducing bacteria, etc.). Many chemical and mechanical methods have been used to remove impurities and/or ions. The goal of the processes is to remove a sufficient amount of impurities to allow the treated water to be discharged into the environment or recycled and reused in fracing or other oil field or industrial uses with an acceptable amount of adverse impact or to be reused in various applications.

In some oil and gas production processes, a large volume of water is produced and/or used. For example, recovery of hydrocarbon (e.g., oil) from underground reservoirs often results in recovery of contaminated underground water. In other instances, a large volume of water is used to help facilitate and enhance hydrocarbon recovery from underground reservoirs. The resulting water is contaminated with colloids, various metal ions, and/or microorganisms, and requires removal of these contaminants prior to disposal.

Conventional processes that treat water from hydrocarbon recovery processes (e.g., produced water (PW) or frac flowbackwater) tend to over treat water without regards to the nature of contaminants. Such blanket approaches significantly increase the cost of treating water and/or add a significant amount of time to treat water, particularly if the water is returned to the oil and gas field for reuse verses a higher treatment and quality obtained for discharge into the environment.

The present invention will be described with regard to the accompanying drawings which assist in illustrating various features of the invention. In this regard, the present invention generally relates to processes for treating produced water or any other water that comprises chloride ions, oxidizable ions, and ion reducing microorganism. That is, the invention relates to treating water that comprises chloride ion, an oxidizable ion comprising ferrous ion, sulfide ion, sulfite ion, or a combination thereof, and a microorganism comprising ion reducing bacteria such as, but not limited to, iron reducing bacteria and/or sulfate reducing bacteria.

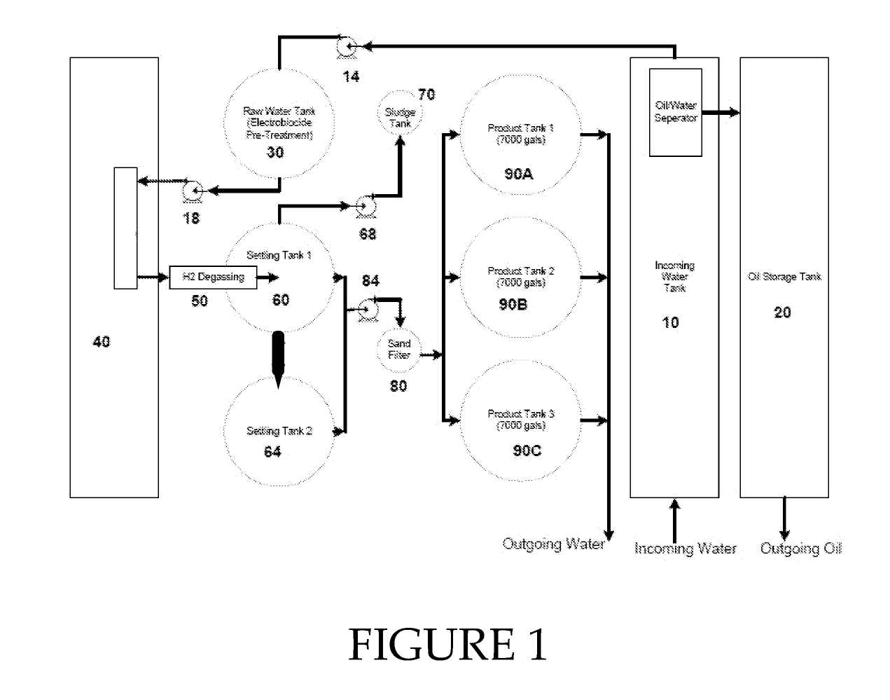

One particular embodiment of treating water is generally illustrated in FIG. 1, which is provided for the purpose of illustrating the practice of the present invention and which does not constitute limitations on the scope thereof.

As stated above, in some aspects of the invention water to be treated comprises chloride ion, oxidizable ion, and ion reducing bacteria. In some embodiments, the oxidizable ion comprises ferrous ion, sulfide ion, sulfite ion, or a combination thereof. Yet in other embodiments, the ion reducing bacteria comprises iron reducing bacteria, sulfur reducing bacteria, or a combination thereof.

While not necessary, in some instances water is first placed in an incoming water tank 10, which can include a solids separator (not shown) to remove any settled solids that may form in the incoming water tank 10. Typically, solids form on the bottom of tank 10; therefore, such solids separator is typically located near the bottom of the tank 10. The solids separator typically includes a valve or other outlet orifice that allows removal of any settled solids from water tank 10. Any hydrocarbon (e.g., oil) that is present in the water floats on top of the water due to its lower density. When colder temperatures exist, heating the tank or other form of enhanced oil water separation can be performed. In some embodiments, hydrocarbon is separated and is can be removed and stored in an oil storage tank 20.

Referring again to FIG. 1, water from tank 10 is then transported, e.g., via a pump 14, to oxidize oxidizable ions to oxidized ions (e.g., ferrous ion to ferric ion), and to reduce the amount of ion reducing bacteria (e.g., IRB, SRB or other ion reducing bacteria) to produce a substantially bacteria free water. Such process can be achieved step wise or it can be done in a single process. For example, electrolysis of chloride ions produces chlorine which serves as an oxidizing agent as well as a biocide. Chloride ions in water are typically removed by filtration such as reverse osmosis or distillation. Another method to remove chloride is by conversion to chlorine gas by electrolysis. Electrolysis of chloride ions also produces hydrogen gas and hydroxides from water. In addition, the chlorine gas that is generated by electrolysis acts as a catalyst and is converted back to chloride through a series of reactions, e.g., one that results in the conversion of ferrous iron for ferric iron. The presence of chloride in the treated water helps maintain the biocide activity which in some instances is important to maintaining a bacteria free plant operation.

The electrolysis of water which contains sodium chloride produces hydroxide compounds according to the following equation:

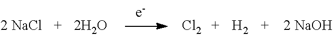

The half reaction in each electrolytic cell is:

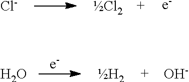

The chlorine (i.e., Cl₂) in salt water at normal pH value typically forms HClO as well as other chloride species. Ultraviolet light at wavelengths of less than about 300 nm, which can be generated readily, dissociate the HClO molecule. Without being bound by any theory, it is believed that HClO molecule dissociates into chlorine, which can emerge from the water as Cl₂ gas, and OH radicals. It is believed that some, but not necessarily all, of the OH will combine with a solvated electron (i.e., e_{aq}) to produce hydroxide ions (i.e., OH⁻).

Thus, some processes of the invention also include removing chloride ions in the aqueous solution. While any conventional chloride ion removal process can be used, as discussed above, often chloride ions are removed by electrolytic process which converts the chloride ions to chlorine gas. Often chloride ions present in the water are activated through a controlled electrolytic process to produce various levels of hypochlorous acid which is effective as a biocide. In many instances, removing chloride ion comprises an electrolytic process or ultraviolet light process. Without being bound by any theory, it is believed that such processes initially convert chloride ions to chlorine gas.

For the sake of brevity and clarity, the present invention will be described for water containing ferrous ions and iron reducing bacteria. However, methods of the invention are also applicable to any water that comprises other oxidizable ions (e.g., sulfide, sulfite, or a combination thereof) and other ion reducing microorganisms (e.g., SRB).

In some embodiments, oxidation of ferrous ion and reduction of the amount of IRB can be achieved by during electrochemical process conversion of chloride ions to chlorine gas, for example, process 30 in FIG. 1). Alternatively, oxidation of ferrous ion to ferric ion and reduction of IRB can be achieved stepwise. It should be appreciated that the sequence of such processes are interchangeable, i.e., reduction of IRB can be done prior to oxidation of ferrous ion and vice versa. Reduction of IRB can be achieved by adding a sufficient amount of biocide to kill substantially all IRBs. Suitable biocides include, but are not limited to, chlorine, bromine, 2,2-dibromo-3-nitrilopropionamide, as well as other biocides that are known to one skilled in the art. Processes of the invention can also use a combination of one or more different biocides.

Regardless of the method used to reduce IRBs, typically an excess amount of biocide is generated (or added) to ensure that all IRBs have been killed. In fact, in some embodiments about 1 ppm or more, typically about 2 ppm or more, often about 3 ppm or more, more often about 5 ppm or more, still more often about 10 ppm of biocide (e.g., chlorine, hypochlorite, bromine, etc.) remain in the initially treated water or the final treated water. In some instances, the biocide (e.g., chlorine) in the initially treated water is removed prior to when the treated water is subjected to a filtration process, e.g., reverse osmosis. It has been shown by the present inventors that in some instances the polymer membrane in reverse osmosis treatment systems deteriorates at a higher rate when chlorine is present in the water. Accordingly, in some embodiments, the chlorine is removed (e.g., addition of sodium bisulfate or other methods knows to one skilled in the art) prior to reverse osmosis and re-added after the reverse osmosis process to maintain bacteria free product water for re-use. Oil field tanks and equipment are substantially contaminated with bacteria and in many cases predominantly IRB and SRB. The present methods include maintaining residual biocide (e.g., chlorine) levels to ensure bacteria free water is delivered to the next frac site or other use. In many embodiments, the level of biocide is maintained to ensure a substantially microbial (e.g., IRB and/or SRB) free water.

It has also been found by the present inventors that when an electrocoagulation (“EC”) process is used, the redox potential of water effects the amount of coagulation (e.g., precipitation). Generally, the higher redox potential results in faster coagulation, larger floc formation and faster settling times. Without being bound by any theory, it is believed that when the redox potential is low, the bulk of the EC process is spent oxidizing ferrous ions to ferric ions. Accordingly, in some embodiments, the redox potential of water is maintained at 650 mV or higher, for example, by adding an oxidizing agent prior to electrocoagulation. In addition to facilitating coagulation, raising the redox potential to at least 650 mV also reduces the amount of microorganisms present in the water.

Substantially IRB free water is then transported via a pump 18 and subjected to a process 40 that facilitates precipitation of suspended solids. Typically, an electrocoagulation process is used to facilitate precipitation of suspended solids. Electrocoagulation is well known to one skilled in the art and various electrocoagulation devices are known and available. In one particular embodiment, an electrocoagulation device disclosed in the commonly owned U.S. Provisional Patent Application No. 61/093,706, filed Sep. 2, 2008, and PCT Patent Application No. PCT/US09/55797, filed Sep. 2, 2009, is used. Such device is described briefly below.

In some cases, electrocoagulation results in production of hydrogen gas which is removed from water, see process 50 in FIG. 1. Treated water is then placed in a settling tank 60 to allow precipitates to settle. Enhanced gravity settlers such as inclined plate settlers are often used in this method, but other methods can be used. The precipitated solids are removed from water through a settling process or through centrifuges, cyclones or other water-solids separation devices. Unlike other conventional processes for treating similar water, the sludge contains a substantially higher amount of solids. Typically the solids contains at least about 3.5% by weight, often at least about 5% by weight, and more often at least about 7% by weight of solids. Because of the high solids content and large floc size, the solids are highly compressible and can be used in a wide variety of applications. For example, the solids are placed in a sludge tank 70, e.g., via pump 68, to allow the sludge to de-water. In some embodiments, a polymer is added to aid in speeding up the de-watering and settling process. The solids are then sent to a further step of de-watering, for example, belt press, centrifuge, cyclone and other method of increasing the % wt by solids in the waste stream. Water can optionally be placed in a second settling tank 64 to further allow solids to precipitate.

After a sufficient amount of sludge separation, the water can be filtered, e.g., through multi-media filter or sand filter 80 or any other suitable filtering device, to remove any residual flocculates, odor of the treated water, or a combination thereof, and placed in a storage tank 90. Depending on the amount of water treated, there can be several storage tanks, e.g., 90A, 90B and 90C.

Treated water can be reused in hydraulic fracing, oil recovery processes or any other processes, or it can simply be disposed of or discharged depending on discharge requirements.

### Electrocoagulation Device

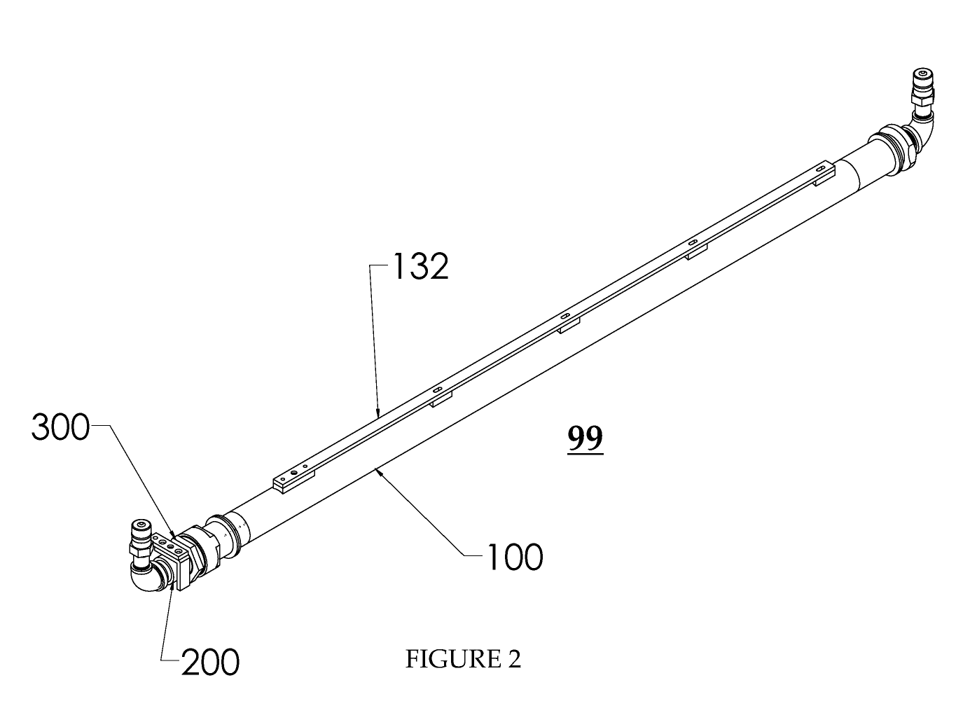

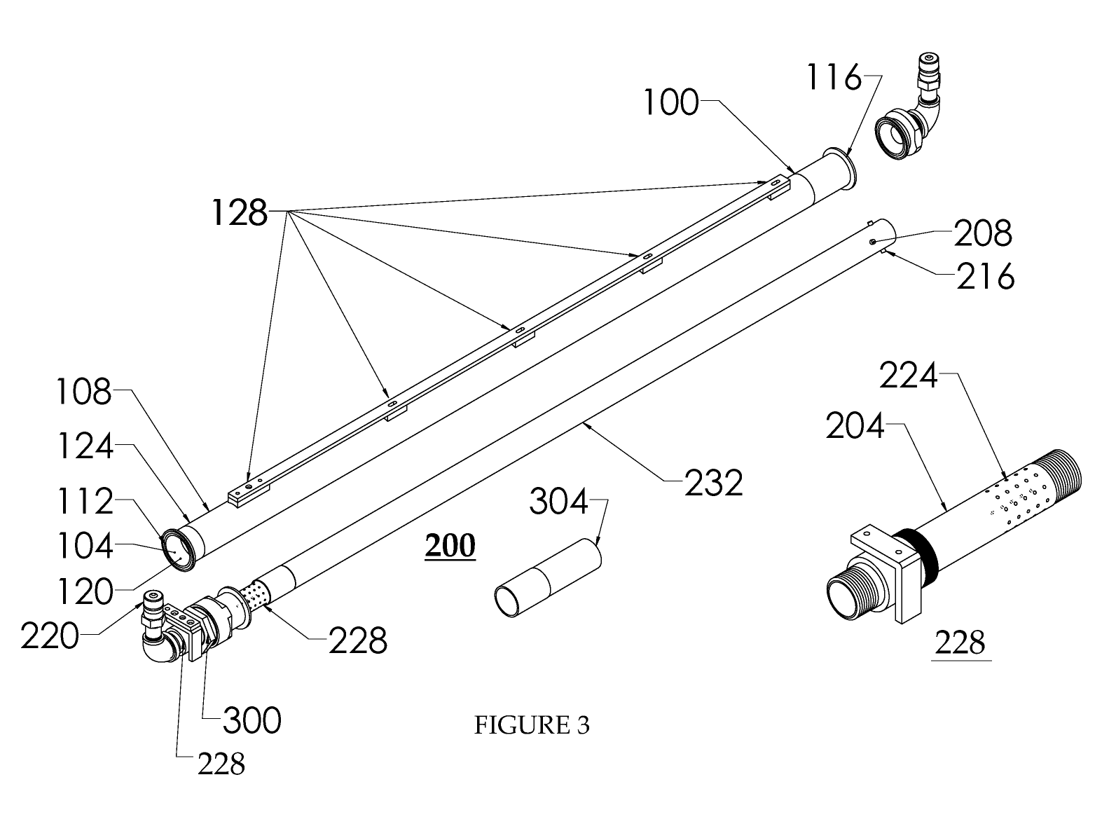

Some aspects of the electrocoagulation devices that are employed in some embodiments of the invention will now be described with regard to the accompanying drawings in FIGS. 2-3, which assist in illustrating various features of the device. In this regard, some aspects of the invention relate to electrocoagulation devices that comprise a tube and a tube insert. That is, some aspects of the invention relate to electrocoagulation device configurations comprising a tube and a tube insert positioned within the tube. It should be appreciated that FIGS. 2-3 are provided solely for the purpose of illustrating one particular embodiment of the electrocoagulation device that is used in some embodiments of the invention and do not constitute limitations on the scope thereof. Some aspects of the electrocoagulation process aspect of the invention relate to facilitating precipitation of colloids, suspended solids, and/or ions.

Without being bound by any theory, it is believed that in a typical electrocoagulation device, sacrificial electrodes are used to generate the coagulating agent—generally aluminum or iron ions. Once the water has been treated by the electrocoagulation device, it is typically filtered, allowed to settle or sent to a gas or air flotation unit to remove the contaminants. Electrocoagulation process offers a number of potential advantages.

Referring to FIGS. 2-3, some aspects of an electrocoagulation device 99 comprises an electrically conducting tube 100, an electrically conducting tube insert 200 that is located and positioned within tube 100, and a non-electrically conducting connector 300. The inner diameter 104 of tube 100 and the outer diameter 204 of tube insert 200 are selected such that there is an annular space (not shown) between tube 100 and tube insert 200 to allow flow of a fluid within electrocoagulation device 99.

Tube 100 also includes an outer diameter 108, a first orifice 112, and a second orifice 116. Second orifice 116 is located distal to first orifice 112 and is configured to allow a fluid to flow out of electrocoagulation device 99. In operation, tube insert 200 is inserted into tube 100 through first orifice 112. In some embodiments, tube insert 200 includes one or more of spacer elements 208 which prevents a direct contact between inner surface 120 of tube 100 and the outer surface of tube insert 200. In some instances, spacer element 208 comprises a plurality of protuberances 216. Within first orifice 112, non-electrically conducting connector 300 is positioned between tube 100 and tube insert 200 thereby electrically isolating tube 100 and tube insert 200. It should be appreciated that tube insert 200 can be held within tube 100 using any connecting mechanism known to one skilled in the art including, but not limited to, nut-and-bolt configuration, and simply by snugly fitting non-electrically conducting connector 300 into first orifice 112 and then snugly fitting tube insert 200 within non-electrically conducting connector 300. Regardless of the connecting mechanism used, tube 100 and tube insert 200 are connected using a connecting mechanism that has a sufficient resistance or friction to withstand any fluid pressure that is applied to electrocoagulation device 99.

In some embodiments, outer surface 124 of tube 100 includes a plurality of electric nodes 128 and optionally conducting element 132. One of the purposes of having conducting element 132 is to evenly distribute electric current throughout the entire tube 100 through each of the electrical contact points 128 simultaneously. However, it should be appreciated that conducting element 132 is not required as one can simply attach an electrical wire (not shown) to each of electric node 128 directly to achieve a similar result. Without being bound by any theory, the conducting element 132 distributes the current across the tube 100, thereby providing a substantially even electrolysis across the length of the tube insert 200 resulting in prolonged life of the tube insert 200. In some instances, it has been found by the present inventors that use of a plurality of electric nodes 128 prevents a single point of contact that can “burn” a hole in the tube 100.

Tube 100 can comprise any material as long as voltage can be applied to allow flow of electricity between tube 100 and tube insert 200 when in operation. Typically, tube 100 comprises a metal or an electric conducting polymer. Exemplary materials of which tube 100 can comprise include, but are not limited to, aluminum, copper, nickel, zinc, silver, titanium, iron, stainless steel, monel, and a combination thereof.

Tube insert 200 can be a single piece or it can comprise two or more pieces that are joined together as long as the materials used for tube insert 200 are electrically conducting such that electricity flows between tube 100 and tube insert 200 during operation. Tube insert 200 comprises a fluid inlet 220 and a plurality of fluid outlet orifices 224. Fluid inlet 220 is typically located proximal to first orifice 112. In operation, a fluid enters electrocoagulation device 99 through fluid inlet 220 and exits tube insert 200 through fluid outlet orifices 224. The fluid then travels down the annular space (not shown) between tube 100 and tube insert 200 while being subjected to electricity and exits through second orifice 116.

Tube insert 200 can be a tube having a closed distal end (distal relative to fluid inlet 220) or it can comprise two or more separate elements that are connected together. In some embodiments, tub insert 200 comprises an electrically conducting tube portion 228 and an electrically conducting solid portion 232. It should be appreciated that electrically conducting solid portion 232 need not be solid throughout: it can be a tube that is closed on both ends. Generally, different elements of tube insert 200 are interconnected such that it allows application of voltage through substantially the entire length of tube insert 200. Interconnection of different elements of tube insert 200 can be achieved using any of the connecting methods known to one skilled in the art including permanent connection and removable connection. For example, electrically conducting tube portion 228 and electrically conducting solid portion 232 can be removably attached by a snap-and-plug mechanism or by a nuts-and-bolt mechanism; or it can be permanently attached, e.g., by soldering the two elements together. It has been found by the present inventors, that using a removably attachable mechanism allows facile replacement of the electrically conducting solid portion 232, which wears or degrades faster than electrically conducting tube portion 228 in certain embodiments. In some embodiments, the electrically conducting tube portion 228 comprises a plurality of radially positioned fluid outlet orifices 224. In some cases, the electrically conducting tube portion 228 is electrically shielded, e.g., using a non-electrically conducting shield 304.

As stated above, in some embodiments, tube insert 200 comprises a plurality of spacer elements 208 to avoid direct contact between tube insert 200 and tube 100. Spacer element 208 is typically made from a non-electrically conducting material, such as Teflon® or other non-electrically conducting polymer or material. Spacer element 208 can be attached to tube insert 200 using any of the methods known to one skilled in the art. For example, spacer element 208 can be (1) a ring of non-electrically conducting material to which tube insert 200 is inserted; (2) a plurality of a portion of a ring (e.g., an arc configuration) placed within different portions of tube insert 200 to allow tube insert 200 to be placed within inner diameter 104 of tube 100 without allowing a direct contact between tube insert 200 and tube 100; (3) one or more spacer inserts within tube insert 200 such that one or more ends of the spacer insert protrude out of tube insert 200, thereby preventing tube insert 200 from contacting tube 100.

In some embodiments, the electrically conducting tube portion 228 comprising the plurality of fluid outlet orifices 224 is electrically shielded by placing an electrical shielding element 304 between tube 100 and the electrically conducting tube portion, 228 comprising the plurality of fluid outlet orifices 224. In some embodiments, electrical shielding element 304 is as long as or slightly longer than the length of electrically connecting tube portion 228, thereby shielding the entire length of electrically connecting tube portion 228. Without being bound by any theory, it is believed that by placing electrically shielding element 304, flow of electricity between tube 100 and the electrically conducting tube portion 228 comprising the plurality of fluid outlet orifices 224 is substantially reduced, thereby substantially extending the life of electrically connecting tube portion 228.

In some embodiments, electrocoagulation device 99 also includes means for purging the annular space to flush out any solid residues that may have accumulated or built-up during operation. It has been found by the present inventors that in certain instances the efficiency of electrocoagulation device 99 decreases as its operation time increases. By flushing out the solid materials or build-ups that accumulate within electrocoagulation device 99, the present inventors have found that at least some of the efficiency can be restored. In some embodiments, a mechanism for purging electrocoagulation device 99 includes having T-joints (not shown) proximal to fluid inlet 220 and second orifice 116. The presence of such T-joints allows flushing electrocoagulation device 99 to be achieved without disconnecting from operation.

Current from a power source (not shown) provides power to electrocoagulation device 99. A power supply (not shown) can be used to apply different current through the device.

In one embodiment, the power source provides DC power thereby allowing a constant anode or cathode configuration. In another embodiment, the power source provides periodic AC power thereby alternating anode and cathode configuration temporarily for tube 100 and tube insert 200. When using an AC power source, the polarity of tube 100 and tube insert 200 can change (i.e., switch) at a desired time intervals. Such switching can be done automatically using a timer or some other device that controls the voltage. One of the advantages of using a periodic AC power source is that it significantly reduces the amount of electrical resistance increase due to the build-up of solids (e.g., salts, metallic carbonates and hydroxides) around the metal tube, thus resulting in less maintenance.

When in use, aqueous solution enters tube insert 200 through fluid inlet 220. The aqueous solution then enters the electrically conducting tube portion 228 into the annular space (or cavity, not shown) between tube 100 and tube insert 200 through a plurality of fluid outlet orifices 224 which are located in tube insert 200. The aqueous solution then travels down the cavity or annular space and exits electrocoagulation device 99 through second orifice 116. Typically, the plurality of fluid outlet orifices 224 is located distal to second orifice 116 to maximize or to provide a relatively long contact time with inner surface 120 of tube 100 and outer surface of tube insert 200. The treated aqueous solution is then discharged through second orifice 116. The solids in the treated aqueous solution are then separated from the liquid with a filter or by retaining it for a period of time in a settling tank or basin (not shown) or by any other methods known to one skilled in the art. As stated above, the negative and positive polarity of the metal tubes can be periodically reversed, either mechanically or automatically, so as to, among others, aid in the cleaning of the cathode portion.

The device described above provides a strong, quick settling, low volume flocculates. Without being bound by any theory, it is believed that the electrocoagulation device of the present invention generates, among others, aluminum hydroxide and/or iron hydroxide. The formation of metal hydroxides is advantageous in that the metal hydroxides are useful in encouraging a coagulating reaction on suspended and colloidal solids.

It is also believed that in addition to the formation of metal hydroxides, the electrocoagulation device of the instant invention also generates, in some instances, metal oxides and complex metal oxides or precipitates. Oxides of this type can, for example, be of iron, nickel, aluminum, chromium, or the like.

Optionally, if brine concentrations are not too high, a complexing agent can also be added to the aqueous solution prior to, during or after undergoing an electrocoagulation process. Exemplary complexing agents include PACl (Poly aluminum chloride). However, typically the methods of the invention do not require any complexing agents, thereby significantly reducing the cost and the chemicals that need disposal.

In addition to the normal oxidation reaction which takes place at the anode, in some instances an oxidizing agent, e.g., ozone, can be injected into the influent stream to oxidize, destroy, and/or degrade at least some of the organic compounds that maybe present in the aqueous solution. Hydrogen can also form at the cathode. In some instances, hydrogen gas bubbles, which float the formed waste (e.g., flocculates) to the surface of the solution where they can be skimmed off.

The tube insert 200 can have a plurality of fluid outlet orifices 224 that allow the aqueous solution to pass into the annulus or the cavity.

As discussed above, in some embodiments the polarity of cathode and anode is alternatively switched using an AC power source 400. Switching of the polarity of cathode and anode aids in the cleaning or reduction of solid material build-up of the metal tubes.

Methods of the invention can also include adding materials to the aqueous solution to be treated. Such materials include acids, bases, polymers, air, oxygen, carbon dioxide, ozone, carbonate ion sources, etc.

In some instances, precipitated colloids and carbonates that are formed within the annular space (e.g., along the cathode wall) by the electrocoagulation process can be separated or removed by adding hydrochloric acid into the influent stream, or the like into the liquid or aqueous solution. Such a process allows the solids to be removed from the cathode wall or the annular space and the resulting metal ions are discharged in the subsequent settling process and removed. Removing cathodic buildup reduces the electrical resistance of the electrocoagulation device, thereby allowing the electrocoagulation process to be operated at a lower voltage. This reduction in current or voltage increases the life span of the electrocoagulation device.

Additional objects, advantages, and novel features of this invention will become apparent to those skilled in the art upon examination of the following examples thereof, which are not intended to be limiting.

### EXAMPLES

This example shows the calculated rates of flocculation and of settling as a function of water temperature.

### Flocculation

The flocs are formed due to the Brownian motion of the suspended colloidal particles (perikinetic flocculation), which themselves are too small to settle out. Brownian motion is described by a form of Newton's second law, F=ma, known as Langevin's equation:

mdu/dt=−ξ+A(t)+F(t)

where ξ=6πrη is the friction constant for a sphere of radius R in a fluid of viscosity η. A(t) is a randomly and rapidly fluctuating force on the particle due to collisions with fluid molecules. F(t) represents any other forces, such as gravity or electrostatic attraction, acting on the particle.

This stochastic differential equation is solvable in terms of an analytic probability function:

W(r−rₒ,u,uₒ;t)

The distribution consists of transient terms involving the factor exp(−ξt/m), which decay away in several collision times. The long time scale expression for the diffusive mean square displacement when F(t)=0 is:

<|r−rₒ|²>=6kT/ξ=6Dt

where the diffusion coefficient is:

D=kT/=kT/ξ=kT/6πRη

In two particles having opposite charges Q₁=q₁e and Q₂=q_{z}e, the attractive force is:

F_{Q}(r)=q₁q₂e²/r²

The flocculation rate is proportional to the flux:

Γ(r)=4πr²[DdN(r)/dr+μF_{Q}(r)N(r)]

where N(r) is the colloidal number density and μ is the charged particle mobility. Using Einstein's relation:

D/μ=kT/e

the mobility is given by:

μ=e/6πRη

The density of water increases with decreasing temperature to a maximum density near 4° C. and then decreases between 4° C. and 0° C. The viscosity of liquid water increases with decreasing temperature as shown in the following Figure:

A standard numerical fit to η(T) is:

η(T)=a10^{[b/(T-c)]}(Pa-sec)

where a=2.414×10⁻⁵, b=247.8, c=140, and T is in ° K.

Below figure shows the so-called logarithmic derivative of the diffusion coefficient, i.e., D⁻¹∂D(T)/∂T:

As shown in the graph, the curve changes dramatically near T=10° C. (50° F.). At T=50° F. the diffusion coefficient is decreasing by about 10% per degree C.

The figure below shows the graph of diffusion coefficient ratio D(T)/D(25° C.) as a function of temperature:

The decrease in the diffusion coefficient with temperature and, similarly, the decrease in mobility with decreasing T are clearly going to slow down the rate of flocculation considerably.

### Settling

Using the equation of motion for particles and flocs of density p and volume V settling due to gravity, the following equation is derived:

mdu_{z}/dt=−(ρ−ρ_{H2O})Vg+6πRη(T)u+A(t)

where the first term is the force in the −z direction due to gravity minus the buoyancy (i.e. Archimedes') force minus Stokes' frictional force. Ignoring the fluctuating force A(t), the following equation is obtained for the terminal velocity in the −z direction of a particle:

u_{z}=−(ρ−ρ_{H2O})Vg/6ηRη(T)

The ratio of the terminal velocity u_{z}(T)/u_{z}(25° C.) is graphed below:
This is mostly due to the viscosity temperature dependence. In all these calculations the temperature dependency of the density of liquid water has a very small effect. As can be seen, the settling rate decreases with water temperature.

The present inventors have observed that at temperature below about 65° F. (about 18° C.), floc formation was slow and the size of floc growth was limited. In addition, the viscosity of water changed significantly below this temperature. Thus, without being bound by any theory, it is believed that the floc formation and growth is limited by water viscosity. As a result, the operational conditions of the methods of some embodiments include operational temperatures above 65° F.

The present inventors have also discovered that the amount of oxidizer added or generated as chlorine gas from chloride ion must be sufficient to convert all reduced iron and sulfur compounds to a fully oxidized stage (e.g., oxidizing ferrous ion to ferric ion) for the most effective precipitation of iron in the form of iron oxide and highest level of performance of the electrocoagulation system. In some embodiments, effective oxidizing of iron and sulfur ions provided 99%+ removal of iron and sulfur contaminants.

### Example 1

Produced water that was recovered from a gas well in Texas was analyzed, and the results are shown in Table 1 below.

TABLE 1
Analysis result of water from an oil recovery process.

| Cations | | Anions | |
|---|---|---|---|
| Ion | Concentration (mg/L) | Ion | Concentration (mg/L) |
| Na⁺ | 30420.00 | Cl⁻¹ | 74780.00 |
| Ca⁺² | 7818.00 | HCO₃⁻¹ | 161.74 |
| Sr⁺² | 1224.00 | SO₄⁻² | 97.60 |
| Mg⁺² | 844.00 | CO₃⁻² | 1.00 |
| K⁺ | 512.00 | | |
| Ba⁺² | 38.44 | | |
| Fe⁺² | 36.05 | | |
| Al⁺³ | 6.40 | | |

### Example 2

The following table shows the before and after result of treating water of Example 1 in accordance with the invention. These analytical results shown were produced by processing water from Example 1 in two stages. Initial processing was performed by subjecting water with quality as shown in Example 1 through the electrocoagulation process which effectively removed suspended solids, iron, silica & silicon, bacteria and oil & grease. The treated water was allowed to settle for several minutes and then clarified through a simple media filter to remove remaining unsettled solids. This water was then subjected to second stage processing which significantly removed Total Hardness including Magnesium & Calcium and other hardness ions. All processing was done at room temperature (e.g., 20° C.).

| | Before | | After | % | |
|---|---|---|---|---|---|
| Parameter | Treatment | | Treatment | Reduction | Comments |
| Total Hardness | 24,000 | mg/L | 350 mg/L | 98.54% | Almost total removal of Scaling |
| (as CaCO₃) | | | | | Species |
| pH | 6.8 | | 7.0-7.4 | | |
| Total Suspended | 1740 | NTU | 1.64 NTU | 99.91% | Processed water is visually |
| Solids | | | | | crystal clear |
| Iron | 16 | mg/L | Undetected | >99.99% | Almost total Iron removal |
| Calcium | 7800 | mg/L | See Total | 98.54% | |
| Magnesium | 840 | mg/L | Hardness | | |
| Silicon | 14.4 | mg/L | 1.9 | 87.10% | |
| Total Bacteria | | | >99.9% Kill | 99.9% | 3 orders magnitude reduction. |
| (IRB, SRB) | | | Rate | | |
| Oil & Grease | 6.6 | mg/L | Undetected | >99.99% | Almost total Oil & Grease |
| (Method 1664) | | | | | removal |

| | | |
|---|---|---|
| Volatile Organic | Removed to | Up to 50% of the hydrocarbons |
| Compounds | low level | are removed from the aqueous |
| | | phase. Other hydrocabons are |
| | | broken down to low levels of |
| | | water soluble hydrocarbons, in |
| | | particular acetone. |

### Example 3

The rate of flocculation and the water clarity using methods of the invention was compared with other conventional methods.

When compared to conventional methods such as polymer or PACl addition, methods of the invention produced flocculates faster. Also, in treating high brine concentrations the addition of PACl's and other polymers are prohibitive due to the fact that a large amount of the polymers are needed with high brine levels. In addition, flocculates produced by methods of the invention separated from the water and formed what appeared to be a relatively more “unified mass” of flocculates more readily. Furthermore, visually the size of flocculates appeared to be larger using methods of the invention.

Significantly, the flocculates produced by methods of the invention appeared to settle faster and produced clarified water faster than the other processes. In addition, it was observed that the flocculates produced by methods of the invention appeared to coagulate and/or attach to other material more rapidly than the flocculates from the other processes. For example, when a pipette was inserted to take a water sample, the flocculates had a much greater tendency to stick to the pipette than the flocculates formed from other processes. Without being bound by any theory, it is believed that the flocculates produced by processes of the invention have a greater affinity for forming a mass (e.g., coagulate) than other processes.

### Example 4

The following data set shows the effect of electrocoagulation with and without the addition of chlorine generated electrically immediately prior to entering the EC device.

Produced Water Treated at Different Temperatures with and without Chlorine

| | | | | 85° F. EC and | |
|---|---|---|---|---|---|
| | Untreated | 85° F. | % | Chlorine | % |
| | Water | EC only | Reduction | Electrolyzer | Reduction |
| pH | 6.59 | 7.88 | N/A | 6.48 | N/A |
| Conductivity (mS/cm) | 29.7 | 29.2 | N/A | 29.7 | N/A |
| ORP (mV) | 19.8 | 101.8 | N/A | 856 | N/A |
| Bacteria (present or not) | + | + | N/A | − | N/A |
| Silica (ppm) | 50 | 15.2 | 69.60% | 9.2 | 81.60% |
| Total Suspended Solids (ppm) | 770 | 8 | 98.96% | 3 | 99.61% |
| Total Dissolved Solids (ppm) | 16300 | 17100 | N/A | 17800 | N/A |
| Total Iron (ppm) | 30 | 0.81 | 97.30% | 0.15 | 99.50% |
| Chloride (ppm) | 15000 | 9625 | 35.83% | 10300 | 31.33% |
| Sulfate (ppm) | 288 | 7 | 97.57% | 7 | 97.57% |
| Turbidity (NTU) | 86.8 | 5.44 | 93.73% | 1.99 | 97.71% |
| Ca hardness as CaCO₃ (ppm) | 1445 | 1350 | 6.57% | 1335 | 7.61% |
| Total hardness as CaCO₃ (ppm) | 1625 | 1535 | 5.54% | 1555 | 4.31% |
| Ca²⁺ (ppm) | 578 | 540 | 6.57% | 534 | 7.61% |
| Chlorine (ppm) | ND | ND | N/A | 130 | N/A |
| Barium (ppm) | 100 | 16 | 84.00% | 17 | 83.00% |

### Example 5

The following data set shows the same data as above, but at a higher temperature demonstrating that high temperatures does not negatively effect EC performance and in some instances, gives better results.

Produced Water Treated at Different Temperatures with and without Chlorine

| | | | | 120° F. EC | |
|---|---|---|---|---|---|
| | Untreated | 120° F. | % | and Chlorine | % |
| | Water | EC only | Reduction | electrolyzer | Reduction |
| pH | 6.59 | 7.91 | N/A | 7.8 | N/A |
| Conductivity (mS/cm) | 29.7 | 30.4 | N/A | 29.5 | N/A |
| ORP (mV) | 19.8 | 239 | N/A | 239 | N/A |
| Bacteria (present or not) | + | + | N/A | − | N/A |
| Silica (ppm) | 50 | 13.6 | 72.80% | 6.1 | 87.80% |
| Total Suspended Solids (ppm) | 770 | 1 | 99.87% | 2 | 99.74% |
| Total Dissolved Solids (ppm) | 16300 | 15500 | 4.91% | 16400 | N/A |
| Total Iron (ppm) | 30 | 0.2 | 99.33% | 0.04 | 99.87% |
| Chloride (ppm) | 15000 | 8500 | 43.33% | 11000 | 26.67% |
| Sulfate (ppm) | 288 | 7 | 97.57% | ND | 100.00% |
| Turbidity (NTU) | 86.8 | 0.71 | 99.18% | 0.4 | 99.54% |
| Ca hardness as CaCO₃ (ppm) | 1445 | 1355 | 6.23% | 1330 | 7.96% |
| Total hardness as CaCO₃ (ppm) | 1625 | 1510 | 7.08% | 1470 | 9.54% |
| Ca²⁺ (ppm) | 578 | 542 | 6.23% | 532 | 7.96% |
| Chlorine (ppm) | ND | ND | N/A | 30.8 | N/A |
| Barium (ppm) | 100 | 17 | 83.00% | 17 | 83.00% |

In both examples above, the reader can see clear advantages of combining on-site addition of bleach or electrically generated chlorine prior to the electro coagulation process to oxidize iron and sulfur and other metals as well as produce a lower turbidity (i.e. “cleaner”) treated water product that can be further treated to remove additional hardness and salts.

### Example 6

The following example shows how increasing the EC cell current (dosage rate) results in greater removal of compounds from water. Increasing residence time will accomplish similar results, however, a key objective of applications in industry or the energy sector require treatment of large volumes of water, thus the design of the EC cells allows for scalable high volume water treatment and the current applied has a strong effect on the ability of the EC cell to remove contaminants.

Produced Water Treated at Different EC Cell Currents

| | Untreated | Amp*min/gal | | | | Final % |
|---|---|---|---|---|---|---|
| | Water | 30 | 60 | 90 | 200 | Reduction |
| pH | 7.7 | 8.4 | 8.3 | 8.4 | 9.1 | N/A |
| Specific Conductance | 10500 | 10300 | 10200 | 10500 | 11000 | N/A |
| (μmhos/cm) | | | | | | |
| Aluminum (ppm) | ND | 3.82 | 9.05 | 17.8 | 11.6 | N/A |
| Barium (ppm) | 4.86 | 2 | 1.16 | 1.04 | 0.0327 | 99.33% |
| Boron (ppm) | 12.5 | 12.4 | 12 | 11.8 | 10.8 | 13.60% |
| Calcium (ppm) | 12.4 | 14.3 | 10.1 | 5.78 | 0.936 | 92.45% |
| Iron (ppm) | 0.844 | 0.222 | 0.154 | 0.197 | ND | 100.00% |
| Magnesium (ppm) | 2.31 | 2.73 | 2.5 | 2.22 | 0.868 | 62.42% |
| Sodium (ppm) | 2330 | 2380 | 2220 | 2290 | 2350 | |
| Chloride (ppm) | 1980 | 1810 | 1720 | 1910 | 1900 | 4.04% |
| Sulfate (ppm) | 10.9 | 11.4 | 10.2 | 10.2 | 12 | |
| Alkalinity, Bicarbonate as | 2490 | 2540 | 2560 | 2570 | 1850 | 25.70% |
| CaCO₃ (ppm) | | | | | | |
| Alkalinity, Carbonate as | ND | ND | ND | ND | 481 | |
| CaCO₃ (ppm) | | | | | | |
| Alkalinity, Total as CaCO₃ | 2490 | 2540 | 2560 | 2570 | 2330 | 6.43% |
| (ppm) | | | | | | |
| Total Suspended Solids (ppm) | 8 | 18 | 26 | 30 | 36 | |
| Total Dissolved Solids (ppm) | 5680 | 5730 | 5470 | 6350 | 5600 | |
| Total Hardness (ppm) | 43.6 | 52 | 44 | 40 | ND | 100.00% |
| Silica (ppm) | 78.5 | 41.5 | 44.1 | 13.6 | 1.93 | 97.54% |
| Benzene (ppm) | 7.33 | 1.83 | 3.6 | 2.85 | 0.801 | 89.07% |
| Ethylbenzene (ppm) | 0.143 | ND | ND | ND | ND | 100.00% |
| Toluene (ppm) | 7.55 | 1.49 | 3.04 | 2.39 | 0.531 | 92.97% |
| Xylenes, Total (ppm) | 1.7 | 0.256 | 0.524 | 0.42 | 0.0665 | 96.09% |
| Oil and Grease (ppm) | 29.9 | ND | ND | ND | ND | 100.00% |
| Methanol (ppm) | 89.7 | 68.7 | 70.3 | 65.3 | 81.8 | 8.81% |
| Total Organic Carbon (ppm) | 294 | 312 | 295 | 310 | 275 | 6.46% |

### Example 7

The following example looks at the effect of treating PW by electrocoagulation combined with air stipping for high removal rates of volatile organic carbons (VOCs) from water. Up to 50% of the VOC's are removed in the EC process, followed by near 100% total removal by the combined EC and air stripping process.

Produced Water Treated by Electro coagulation and Air Stripper

| | Pre- | Post- | % |
|---|---|---|---|
| Volatile Organics | treatment | treatment | Reduction |
| Acetone (ppm) | 69.9 | 44.1 | 36.91% |
| Benzene (ppm) | 0.0984 | ND | 100.00% |
| 2-Butanone (ppm) | 0.232 | ND | 100.00% |
| n-Butylbenzene (ppm) | 0.0168 | ND | 100.00% |
| sec-Butylbenzene (ppm) | 0.0056 | ND | 100.00% |
| Chloroform (ppm) | 0.0154 | ND | 100.00% |
| Dibromomethane (ppm) | 0.0083 | ND | 100.00% |
| Ethylbenzene (ppm) | 0.0115 | ND | 100.00% |
| p-Isopropyltoluene (ppm) | 0.0069 | ND | 100.00% |
| n-Propylbenzene (ppm) | 0.0067 | ND | 100.00% |
| Toluene (ppm) | 0.23 | ND | 100.00% |
| 1,2,4-Trimethylbenzene (ppm) | 0.0892 | ND | 100.00% |
| 1,3,5-Trimethylbenzene (ppm) | 0.0411 | ND | 100.00% |
| Xylene, Total (ppm) | 0.234 | ND | 100.00% |

### Example 8

Similar to Example 7, the following example looks at the effect of treating PW with electrocoagulation combined with air stipping for high removal rates of semi-volatile organic carbons (SVOCs) from water. Up to 50% of the SVOC's are removed in the EC process followed by near 100% total removal by the combined EC and air stripping process.

Produced Water Treated by Electro coagulations and Air Stripper

| | Pre- | Post- | % |
|---|---|---|---|
| Semi-Volatile Organics | treatment | treatment | Reduction |
| 2,4-Dimethylphenol (ppm) | 0.221 | ND | 100.00% |
| 1-Methylnaphthalene (ppm) | 0.0303 | ND | 100.00% |
| 2-Methylnaphthalene (ppm) | 0.0754 | ND | 100.00% |
| 2-Methylphenol (ppm) | 1 | ND | 100.00% |
| m&p Cresol (ppm) | 0.836 | ND | 100.00% |
| Naphthalene (ppm) | 0.0128 | ND | 100.00% |
| Phenanthrene (ppm) | ND | ND | N/A |
| Phenol (ppm) | 1.71 | ND | 100.00% |

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A process for treating water which comprises chloride ion, oxidizable ion, suspended solids, and ion reducing bacteria, said process comprising:
oxidizing an oxidizable ion to produce an oxidized ion, wherein the oxidizable ion comprises ferrous ion, sulfide ion, sulfite ion, or a mixture thereof;
reducing the amount of ion reducing bacteria to produce a substantially ion reducing bacteria free water, wherein the ion reducing bacteria comprises iron reducing bacteria, sulfur reducing bacteria, or a mixture thereof;
subjecting the substantially ion reducing bacteria free water to conditions sufficient to precipitate suspended solids; and
separating at least a substantial portion of the precipitated suspended solids from the substantially ion reducing bacteria free water to produce a treated water.

2. The process of claim 1 further comprising removing precipitated solids that have formed prior to said step of subjecting the substantially ion reducing bacteria free water to precipitating suspended solids conditions.

3. The process of claim 1, wherein said step of oxidizing the oxidizable ion to the oxidized ion comprises an electrochemical process of converting chloride ion to chlorine.

4. The process of claim 1, wherein said step of oxidizing the oxidizable ion to the oxidized ion comprises adding an oxidizing agent comprising ozone, bleach, chlorine dioxide, or a combination thereof.

5. The process of claim 1, wherein said step of reducing the amount of ion reducing bacteria comprises electrochemical process.

6. The process of claim 5, wherein said electrochemical process of reducing the amount of ion reducing bacteria comprises converting chloride ion to chlorine.

7. The process of claim 1, wherein said step of precipitating the suspended solids comprises producing flocculates, ferric hydroxide (Fe(OH)₃) or a combination thereof.

8. The process of claim 1, wherein said step of precipitating suspended solids comprises subjecting the substantially ion reducing bacteria free water to an electrocoagulation process.

9. The process of claim 8, wherein said electrocoagulation process uses an electrocoagulation device comprising:
an electrically conducting tube connected to an electrical source and comprising:
an inner diameter;
an outer diameter;
a proximal end having an electrically conducting tube insert inserted therein such that there is an annular space between the tube and the tube insert; and
a fluid outlet distal to the proximal end for allowing a fluid to flow out of the electrocoagulation device,
wherein the electrically conducting tube insert is connected to an electrical source and is axially aligned and positioned within the inner diameter of the tube, and wherein the tube insert is positioned within the tube such that the electrically conducting portion of the tube insert does not come in direct contact with the electrically conducting tube, and wherein the tube insert comprises:
a water inlet that is proximal to the proximal end of the tube for allowing a fluid to flow into the electrocoagulation device; and
a plurality of fluid outlet orifices for allowing a fluid to flow out of the tube insert and out into the annular space of the electrocoagulation device,
wherein one of the tube and the tube insert forms an anode and the other forms a cathode of the electrocoagulation device.

10. The process of claim 9, wherein the electrocoagulation device further comprises an electrically non-conducting material within the annular space of the electrocoagulation device such that the electrically non-conducting material prevents a direct contact between electrically conduction portions of the tube and the tube insert.

11. The process of claim 9, wherein said electrocoagulation process uses a plurality of electrocoagulation devices.

12. The process of claim 9, wherein said steps of oxidizing the oxidizable ion to produce the oxidized ion; reducing the amount of ion reducing bacteria; and conditions sufficient to precipitate suspended solids are all provided by the electrocoagulation process.

13. The process of claim 1, wherein said step of separating at least a substantial portion of the precipitated suspended solids comprises placing the substantially ion reducing bacteria free water in a solid separation device.

14. The process of claim 13, wherein the solid separation device comprises an incline plate settler, settling tank, centrifuge, other enhanced gravity separation device, or a combination thereof.

15. The process of claim 1 further comprising the step of filtering the treated water.

16. The process of claim 15, wherein said filtering step reduces flocculates, odor of the treated water, or a combination thereof.

17. The process of claim 1, wherein the treated water comprises chlorine.

18. The process of claim 1, wherein the separated precipitated suspended solids are highly compressible.

19. The process of claim 1, wherein the separated precipitated suspended solids comprise at least 3.5% solids by weight.

20. The process of claim 9, wherein the electrocoagulation device further comprises a non-electrically conducting shield element placed between the electrically conducting tube and the plurality of fluid outlet orifices.

21. The process of claim 9, wherein the electrocoagulation device further comprises a non-electrically conducting shield element placed between the electrically conducting tube and the plurality of fluid outlet orifices.

22. The process of claim 8, wherein said process is conducted at a temperature of at least about 18° C. (65° F.).

23. The process of claim 1, wherein said step of oxidizing the oxidizable ion to the oxidized ion comprises adding an oxidizing agent.
